(19) United States
(12) Patent Application Publication
(10) Pub. No.: US 2003/0145595 A1
(43) Pub. Date: Aug. 7, 2003

(54) Isolated vapor cycle engine

(76) Inventor: Thomas L. Cosby, Chicago, IL (US)

Correspondence Address: WOOD, PHILLIPS, VAN SANTEN, CLARK & MORTIMER, SUITE 3800, 500 WEST MADISON STREET, CHICAGO, IL, 60661, US

(21) Appl. No.: 10/067,053

(22) Filed: Feb. 4, 2002

(51) Int. Cl. F02G 1/00; F02C 1/04; F01K 25/02

(52) U.S. Cl. 60/650; 60/682

(57) ABSTRACT

A single phase vapor cycle apparatus has a reservoir containing a supply of heated vapor, a turbine for producing a work output, and a compressor downstream of the turbine. The turbine receives the vapor from the reservoir and expands the vapor at an incoming temperature and pressure so that the vapor is exhausted from the turbine at a first temperature and pressure below the incoming temperature and pressure. The compressor receives vapor exhausted from the turbine. Heat is exchanged between vapor entering the compressor and vapor being compressed in the compressor so that the vapor in the compression process is cooled and the vapor entering the compressor is heated to a temperature above the first temperature. The compressed vapor is delivered to the reservoir.

### FIELD OF THE INVENTION

This invention relates to a method and apparatus for performing work in a vapor cycle without requiring phase changes. In particular, the invention relates to a single phase vapor cycle that is a modification of the conventional Rankine Cycle or other phase change cycles.

### BACKGROUND OF THE INVENTION

In the known Rankine Cycle, fuel is used to heat water in a boiler to generate pressurized steam. The steam is superheated and then expanded across a turbine to generate work. Upon exit from the turbine the exhaust steam is condensed to a liquid, making it economical to return it to the boiler with the least amount of parasitic work.

In the above cycle, two phase changes occur:from liquid to vapor and then vapor to liquid. An amount of heat is needed to make the transformation from liquid to vapor, and this amount is removed for the reverse phase change.

This amount of heat is only preparatory and is added/subtracted to make it economical to re-enter the boiler with the smallest volume for the smallest amount of work.

In addition, most turbines used for electricity generation, such as steam generators, expand steam at an incoming volume to its maximum to extract the maximum amount of heat or work from the process. The volume becomes extremely large. Previously there was no thought to compress the steam and return it to the steam generator. The large volume would require an equal or greater amount of work to compress it than was derived from the expansion process. At some point, the economical point of no return is passed, i.e., it is no longer possible to obtain a net work output if work used to re-compress the large volume of steam to its incoming volume is larger than or equal to output work.

### SUMMARY OF THE INVENTION

An objective of the present invention is to provide a cycle whereby a phase change from steam or other vapor to water or other liquid is substantially minimized or eliminated, thereby obviating the need for causing the reverse phase change from condensate to vapor in a boiler.

In the previously described cycle, if the expansion is stopped before maximum allowable, or what is currently deemed ideal, and “intra” stage cooling is effected, it becomes possible to perform the compression process and require a relatively low amount of parasitic work. As an example, compression work can be estimated by dh. If the vapor to be compressed is cooled during the process by 50% dh, then 50% of the work of compression is done without mechanical work. Energy saving can thus be realized.

According to the invention, a single phase vapor cycle apparatus has a reservoir containing a supply of heated vapor, a turbine for producing a work output, and a compressor downstream of the turbine. The turbine receives the vapor from the reservoir and expands the vapor at an incoming temperature and pressure so that the vapor is exhausted from the turbine at a first temperature and pressure below the incoming temperature and pressure. The compressor receives vapor exhausted from the turbine. Heat is exchanged between vapor entering the compressor and vapor being compressed in the compressor so that the vapor in the compression process is cooled and the vapor entering the compressor is heated to a temperature above the first temperature. The compressed vapor is delivered to the reservoir.

A method of operating on a vapor to produce work in a system having a turbine and compressor includes delivering the vapor to the turbine at an incoming temperature and pressure. The vapor is expanded to develop a work output and exhaust vapor at a first temperature and pressure below the incoming temperature and pressure is produced. The exhausted vapor is delivered to the compressor. Vapor in the compression process is cooled by the exhaust vapor from the turbine. The compressed vapor is delivered to the turbine via the fluid reservoir. Any additional energy necessary to permit the system to continuously operate is added, such as to the reservoir fluid.

Other advantages, objects and features of the present invention will become apparent upon reading the following detailed description of the preferred embodiments in conjunction with the accompanying drawings.

### BRIEF DESCRIPTION OF THE DRAWINGS

FIG. 1 is a schematic block diagram of a single phase vapor cycle apparatus in accordance with one embodiment of the invention; and

FIG. 2 is a graphical representation of entropy versus temperature of the single phase vapor cycle in FIG. 1 and the Rankine Cycle with superheated vapor.

### DESCRIPTION OF THE PREFERRED EMBODIMENTS

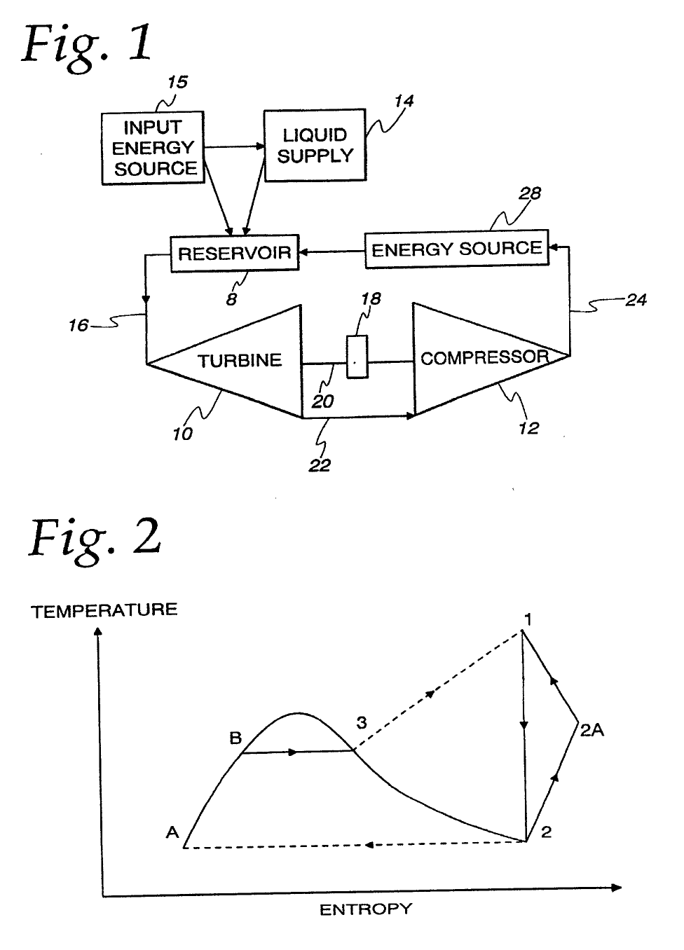

Referring initially to FIG. 1, a single phase vapor cycle apparatus according to the present invention is shown schematically and includes a reservoir 8, a turbine 10 and a compressor 12. To initiate a cycle, a liquid in a supply 14 is heated by from an input energy source 15 to generate a vapor. The vapor is superheated to a high temperature and pressure in the reservoir 8. Once sufficient vapor is produced, only the following cycle is performed. The high temperature and pressure vapor is delivered through a conduit 16 to the turbine 10. In the turbine 10 the high temperature and pressure vapor is expanded and exhausted at a temperature and pressure lower than the high temperature and pressure of the incoming vapor. The amount of expansion is limited to a point where it is still feasible to compress vapor economically. Work is then extracted by any of a number of conventional power take-off devices 18 powered by a drive shaft attached to the turbine output shaft 20. The shaft 20 also drives the compressor 12.

Exhaust vapor from an output of the turbine 10 is delivered through a conduit 22 to the compressor 12. The incoming exhaust vapor is at a temperature lower than that of the vapor being compressed in the compressor 12. The cooler vapor entering the compressor 12 cools the vapor already in the compression process, and absorbs the heat of compression. An internal exchange occurs. The compressor 12 pressurizes the vapor and delivers the same to the high pressure reservoir 8 through a conduit 24. The vapor at high temperature and pressure is then delivered from the reservoir 8 through the conduit 16 to the turbine expansion and work production and for completion of the vapor circuit/cycle.

Optionally, included is an energy source 28 for providing the system with any required work or heat to keep the system in continuous operation and/or for heating the vapor in the cycle to increase a net work output. The energy source 28 may be place anywhere throughout the system, as/if needed. The placement of the energy source 28 shown is not definitive, but rather only illustrative. The make-up liquid 14 and input energy 15 also serve as an energy source for the same purpose.

From the foregoing, it will be appreciated that in the above cycles, phase change from vapor to liquid may be substantially minimized or eliminated. As a result of cooling the compressed vapor in the compressor 12 by the cooler vapor entering the compressor 12, the heat generated when vapor is compressed may be recycled internally in the compression process. The amount of energy necessary to heat the vapor in the reservoir 8 may be reduced. It should also be appreciated that as a result of cooling simultaneously during the compression process, mechanical compression work may be reduced.

The examples below are intended to set forth application of the apparatus and method of the present invention. Furthermore, though the embodiments hereinbefore described are preferred, other modifications are contemplated.

### EXAMPLE

Comparisons between the Rankine Cycle and the single phase vapor cycle are illustrated graphically in FIG. 2 with the temperature represented on the Y axis and entropy on the X axis. The Rankine Cycle is indicated by A-B-3-1-2-A. Starting the cycle from state B, the working fluid enters a boiler, as a liquid. The liquid is heated to change the state of the liquid to a saturated liquid and, ultimately, to that of a saturated vapor at state 3. The vapor is usually further superheated to state 1. By taking water as an operating liquid, a representative heat content for the high pressure/temperature point is approximately 1368 BTU/LB of which approximately 48 BTU/LB is atmospheric heat and 1320 BTU/LB is added during each cycle. Of the 1320 BTU/LB, approximately 950 BTU/LB is required in the phase change from water to steam. The vapor leaves the boiler at state 1 and enters a turbine, where the vapor expands isentropically to state 2. Approximately 370 BTU/LB is converted to output work. The vapor enters the condenser at this point and is condensed from state 2 to state A. Approximately 950 BTU/LB of heat is rejected to the atmosphere. The pressure of the liquid is raised by a pump to enter the boiler and the liquid is at state B. Heat is added to raise the temperature of the liquid to the boiling/vaporization point to continue the cycle.

In this system, of 1320 BTU/LB which is added each cycle, only 370 BTU/LB is convertible to work. The 950 BTU/LB is only preparatory and removed from the cycle (950/1320=72%).

An example given in Keenan, Jos. H., “Thermodynamics”, John Wiley & Sons, N.Y., N.Y., 1941 shows 1320 BTU/LB of heat added and 370 BTU/LB of work output. With 950 BTU/LB of heat removed, using this figure, we can calculate: (1320−950)/370=370/370=100% thermal efficiency for the process.

Another example is given in a more recent book: The Thermodynamic Problem Solver, Research and Education Assn., N.Y., N.Y., 1985. In the example, work output is 112 BTU/LB, 1139 BTU/LB of heat is added in a boiler, and 1027 BTU/LB of heat removed in a condenser (1027/1139=90%). Accordingly, (1139−1027)=112 (BTU/LB), which means 100% thermal efficiency.

The difficulty in realizing this potential is how to compress the vapor after the work producing process without using all the work generated. All previous or current inter-stage cooling devices remove heat from the system. The inventive system recycles internally the heat generated when vapor is compressed to realize potential efficiency.

In FIG. 2, 1-2-2a-1 represents the single phase vapor cycle. At point 1, entropy (s) equals 1.6848, temperature (T) equals 772° F., and pressure equals 400 psia. Line 1-2 represents the adiabatic expansion stage, which occurs at constant entropy. At point 2, T equals 281° F., s is unchanged, and the pressure equals 50 psia. Compression heat absorbed by cooler vapor coming into the compressor is indicated by line 2-2a. At point 2a, s equals 1.8115 and the pressure equals 50 psia. Heat absorbed from compression is indicated by line 2a-1.

Flow of cool turbine exhaust lowers the temperature of the compressed vapor. The system is designed to minimize enthalpy increase, and thereby lowers work input. Consequently, the work input to the system may be less than required in a conventional system.

The foregoing detailed description was made for purposes of demonstrating the inventive structure and the operation thereof, with no unnecessary limitations to be understood therefrom.

I claim:

1. A single phase vapor cycle apparatus comprising:
a reservoir containing a supply of heated vapor;
a turbine for producing a work output, the turbine receiving the vapor from the reservoir and expanding the vapor at an incoming temperature and pressure so that the vapor is exhausted from the turbine at a first temperature and pressure below the incoming temperature and pressure; and
a compressor downstream of the turbine to receive vapor exhausted from the turbine and at which heat is exchanged between vapor entering the compressor and vapor being compressed in the compressor so that the compressed vapor in the compressor is cooled and the vapor entering the compressor is heated to a temperature above the first temperature, the compressed vapor being delivered to the reservoir.

2. The single phase vapor cycle apparatus of claim 1 further including an energy source to add any energy necessary to maintain the cycle in continuous operation.

3. The single phase vapor cycle apparatus of claim 2 wherein the energy added by the energy source comprises heated vapor in the reservoir.

4. The single phase vapor cycle apparatus of claim 1 wherein the turbine drives the compressor.

5. A method of operating on a vapor to produce work in a system having a turbine and compressor, the method comprising the steps of:
delivering the vapor to the turbine at an incoming temperature and pressure;
expanding the vapor to develop a work output and exhausting vapor at a first temperature and pressure below the incoming temperature and pressure;
delivering the exhaust vapor to the compressor;
compressing the exhaust vapor;
cooling the compressed vapor in the compressor with the exhaust vapor from the turbine;
delivering the compressed vapor to the turbine; and
introducing any additional energy necessary to the system to permit the system to continuously operate.

6. The method of claim 5 further including the step of delivering the vapor from the compressor to a high pressure reservoir prior to delivery of the vapor to the turbine.

7. The method of claim 5 including the step of connecting the turbine to drive the compressor.
